(19) United States
(12) Patent Application Publication
(10) Pub. No.: US 2017/0310584 A1
(43) Pub. Date: Oct. 26, 2017

(54) ROUTING RULE UPDATING METHOD AND USER DEVICE FOR MOVING SPECIFIC IP FLOW TO SPECIFIC ACCESS

(71) Applicant: LG ELECTRONICS INC., Seoul (KR)

(72) Inventors: Hyunsook KIM, Seoul (KR); Jinsook RYU, Seoul (KR); Laeyoung KIM, Seoul (KR); Jaehyun KIM, Seoul (KR); Taehun KIM, Seoul (KR)

(73) Assignee: LG ELECTRONICS INC., Seoul (KR)

(21) Appl. No.: 15/515,869

(22) PCT Filed: Sep. 30, 2015
(86) PCT No.: PCT/KR2015/010288

§ 371 Date: Mar. 30, 2017

Related U.S. Application Data
(60) Provisional application No. 62/060,557, filed on Oct. 6, 2014.
(60) Provisional application No. 62/060,558, filed on Oct. 6, 2014.

(51) Int. Cl. H04L 12/721; H04W 40/24; H04W 40/34; H04L 12/707; H04W 28/02

(52) U.S. Cl. CPC H04L 45/38; H04W 40/34; H04L 45/22; H04W 40/24; H04W 28/02

(57) ABSTRACT

One disclosure of the present specification provides a routing rule updating method for moving a specific IP flow to a specific access. The updating method can include a step of receiving a routing rule updating request message for network based IP flow mobility (NBIFOM) initiated by a network, wherein the routing rule updating request message can include: a routing rule for moving a specific IP flow of a user device from a first access to a second access; and a timer value calculated by the network. The timer value can be calculated by the network on the basis of at least one of subscriber information, load information and statistical information. The updating method can include the steps of: transmitting an acceptance message to the network in response to the routing rule updating request; and operating a timer according to the timer value.

### BACKGROUND OF THE INVENTION

### Field of the Invention

The present invention relates to a mobile communication.

### Related Art

In 3GPP in which technical standards for mobile communication systems are established, in order to handle 4th generation communication and several related forums and new technologies, research on Long Term Evolution/System Architecture Evolution (LTE/SAE) technology has started as part of efforts to optimize and improve the performance of 3GPP technologies from the end of the year 2004

SAE that has been performed based on 3GPP SA WG2 is research regarding network technology that aims to determine the structure of a network and to support mobility between heterogeneous networks in line with an LTE task of a 3GPP TSG RAN and is one of recent important standardization issues of 3GPP. SAE is a task for developing a 3GPP system into a system that supports various radio access technologies based on an IP, and the task has been carried out for the purpose of an optimized packet-based system which minimizes transmission delay with a more improved data transmission capability.

An Evolved Packet System (EPS) higher level reference model defined in 3GPP SA WG2 includes a non-roaming case and roaming cases having various scenarios, and for details therefor, reference can be made to 3GPP standard documents TS 23.401 and TS 23.402. A network configuration of FIG. 1 has been briefly reconfigured from the EPS higher level reference model.

FIG. 1 shows the configuration of an evolved mobile communication network.

An Evolved Packet Core (EPC) may include various elements. FIG. 1 illustrates a Serving Gateway (S-GW) 52, a Packet Data Network Gateway (PDN GW) 53, a Mobility Management Entity (MME) 51, a Serving General Packet Radio Service (GPRS) Supporting Node (SGSN), and an enhanced Packet Data Gateway (ePDG) that correspond to some of the various elements.

The S-GW 52 is an element that operates at a boundary point between a Radio Access Network (RAN) and a core network and has a function of maintaining a data path between an eNodeB 22 and the PDN GW 53. Furthermore, if a terminal (or User Equipment (UE) moves in a region in which service is provided by the eNodeB 22, the S-GW 52 plays a role of a local mobility anchor point. That is, for mobility within an E-UTRAN (i.e., a Universal Mobile Telecommunications System (Evolved-UMTS) Terrestrial Radio Access Network defined after 3GPP release-8), packets can be routed through the S-GW 52. Furthermore, the S-GW 52 may play a role of an anchor point for mobility with another 3GPP network (i.e., a RAN defined prior to 3GPP release-8, for example, a UTRAN or Global System for Mobile communication (GSM) (GERAN)/Enhanced Data rates for Global Evolution (EDGE) Radio Access Network).

The PDN GW (or P-GW) 53 corresponds to the termination point of a data interface toward a packet data network. The PDN GW 53 can support policy enforcement features, packet filtering, charging support, etc. Furthermore, the PDN GW (or P-GW) 53 can play a role of an anchor point for mobility management with a 3GPP network and a non-3GPP network (e.g., an unreliable network, such as an Interworking Wireless Local Area Network (I-WLAN), a Code Division Multiple Access (CDMA) network, or a reliable network, such as WiMax).

In the network configuration of FIG. 1, the S-GW 52 and the PDN GW 53 have been illustrated as being separate gateways, but the two gateways may be implemented in accordance with a single gateway configuration option.

The MME 51 is an element for performing the access of a terminal to a network connection and signaling and control functions for supporting the allocation, tracking, paging, roaming, handover, etc. of network resources. The MME 51 controls control plane functions related to subscribers and session management. The MME 51 manages numerous eNodeBs 22 and performs conventional signaling for selecting a gateway for handover to another 2G/3G networks. Furthermore, the MME 51 performs functions, such as security procedures, terminal-to-network session handling, and idle terminal location management.

The SGSN handles all packet data, such as a user's mobility management and authentication for different access 3GPP networks (e.g., a GPRS network and an UTRAN/GERAN).

The ePDG plays a role of a security node for an unreliable non-3GPP network (e.g., an I-WLAN and a Wi-Fi hotspot).

As described with reference to FIG. 1, a terminal (or UE) having an IP capability can access an IP service network (e.g., IMS), provided by a service provider (i.e., an operator), via various elements within an EPC based on non-3GPP access as well as based on 3GPP access.

Furthermore, FIG. 1 shows various reference points (e.g., S1-U and S1-MME). In a 3GPP system, a conceptual link that connects two functions that are present in the different function entities of an E-UTRAN and an EPC is called a reference point. Table 1 below defines reference points shown in FIG. 1. In addition to the reference points shown in the example of Table 1, various reference points may be present depending on a network configuration.

TABLE 1

| REFERENCE | |
|---|---|
| POINT | DESCRIPTION |
| S1-MME | A reference point for a control plane protocol between the |
| | E-UTRAN and the MME |
| S1-U | A reference point between the E-UTRAN and the S-GW |
| | for path switching between eNodeBs during handover and |
| | user plane tunneling per bearer |
| S3 | A reference point between the MME and the SGSN that |
| | provides the exchange of pieces of user and bearer |
| | information for mobility between 3GPP access networks |
| | in idle and/or activation state. This reference point can be |
| | used intra-PLMN or inter-PLMN (e.g. in the case of |
| | Inter-PLMN HO). |
| S4 | A reference point between the SGW and the SGSN that |
| | provides related control and mobility support between the |
| | 3GPP anchor functions of a GPRS core and the S-GW. |
| | Furthermore, if a direct tunnel is not established, the |
| | reference point provides user plane tunneling. |
| S5 | A reference point that provides user plane tunneling and |
| | tunnel management between the S-GW and the PDN GW. |
| | The reference point is used for S-GW relocation due to |
| | UE mobility and if the S-GW needs to connect to a non- |
| | collocated PDN GW for required PDN connectivity |
| S11 | A reference point between the MME and the S-GW |
| SGi | A reference point between the PDN GW and the PDN. |
| | The PDN may be a public or private PDN external to an |
| | operator or may be an intra-operator PDN, e.g., for the |
| | providing of IMS services. This reference point |
| | corresponds to Gi for 3GPP access. |

FIG. 2 is an exemplary diagram showing the architecture of a common E-UTRAN and a common EPC.

As shown in FIG. 2, the eNodeB 20 can perform functions, such as routing to a gateway while RRC connection is activated, the scheduling and transmission of a paging message, the scheduling and transmission of a broadcast channel (BCH), the dynamic allocation of resources to UE in uplink and downlink, a configuration and providing for the measurement of the eNodeB 20, control of a radio bearer, radio admission control, and connection mobility control. The EPC can perform functions, such as the generation of paging, the management of an LTE_IDLE state, the ciphering of a user plane, control of an EPS bearer, the ciphering of NAS signaling, and integrity protection.

FIG. 3 is an exemplary diagram showing the structure of a radio interface protocol in a control plane between UE and an eNodeB, and FIG. 4 is another exemplary diagram showing the structure of a radio interface protocol in a control plane between UE and an eNodeB.

The radio interface protocol is based on a 3GPP radio access network standard. The radio interface protocol includes a physical layer, a data link layer, and a network layer horizontally, and it is divided into a user plane for the transmission of information and a control plane for the transfer of a control signal (or signaling).

The protocol layers may be classified into a first layer (L1), a second layer (L2), and a third layer (L3) based on three lower layers of the Open System Interconnection (OSI) reference model that is widely known in communication systems.

The layers of the radio protocol of the control plane shown in FIG. 3 and the radio protocol in the user plane of FIG. 4 are described below.

The physical layer PHY, that is, the first layer, provides information transfer service using physical channels. The PHY layer is connected to a Medium Access Control (MAC) layer placed in a higher layer through a transport channel, and data is transferred between the MAC layer and the PHY layer through the transport channel. Furthermore, data is transferred between different PHY layers, that is, PHY layers on the sender side and the receiver side, through the PHY layer.

A physical channel is made up of multiple subframes on a time axis and multiple subcarriers on a frequency axis. Here, one subframe is made up of a plurality of symbols and a plurality of subcarriers on the time axis. One subframe is made up of a plurality of resource blocks, and one resource block is made up of a plurality of symbols and a plurality of subcarriers. A Transmission Time Interval (TTI), that is, a unit time during which data is transmitted, is 1 ms corresponding to one subframe.

In accordance with 3GPP LTE, physical channels that are present in the physical layer of the sender side and the receiver side can be divided into a Physical Downlink Shared Channel (PDSCH) and a Physical Uplink Shared Channel (PUSCH), that is, data channels, and a Physical Downlink Control Channel (PDCCH), a Physical Control Format Indicator Channel (PCFICH), a Physical Hybrid-ARQ Indicator Channel (PHICH), and a Physical Uplink Control Channel (PUCCH), that is, control channels.

A PCFICH that is transmitted in the first OFDM symbol of a subframe carries a Control Format Indicator (CFI) regarding the number of OFDM symbols (i.e., the size of a control region) used to send control channels within the subframe. A wireless device first receives a CFI on a PCFICH and then monitors PDCCHs.

Unlike a PDCCH, a PCFICH is transmitted through the fixed PCFICH resources of a subframe without using blind decoding.

A PHICH carries positive-acknowledgement (ACK)/negative-acknowledgement (NACK) signals for an uplink (UL) Hybrid Automatic Repeat reQuest (HARQ). ACK/NACK signals for UL data on a PUSCH that is transmitted by a wireless device are transmitted on a PHICH.

A Physical Broadcast Channel (PBCH) is transmitted in four former OFDM symbols of the second slot of the first subframe of a radio frame. The PBCH carries system information that is essential for a wireless device to communicate with an eNodeB, and system information transmitted through a PBCH is called a Master Information Block (MIB). In contrast, system information transmitted on a PDSCH indicated by a PDCCH is called a System Information Block (SIB).

A PDCCH can carry the resource allocation and transport format of a downlink-shared channel (DL-SCH), information about the resource allocation of an uplink shared channel (UL-SCH), paging information for a PCH, system information for a DL-SCH, the resource allocation of an upper layer control message transmitted on a PDSCH, such as a random access response, a set of transmit power control commands for pieces of UE within a specific UE group, and the activation of a Voice over Internet Protocol (VoIP). A plurality of PDCCHs can be transmitted within the control region, and UE can monitor a plurality of PDCCHs. A PDCCH is transmitted on one Control Channel Element (CCE) or an aggregation of multiple contiguous CCEs. A CCE is a logical allocation unit used to provide a PDCCH with a coding rate according to the state of a radio channel. A CCE corresponds to a plurality of resource element groups. The format of a PDCCH and the number of bits of a possible PDCCH are determined by a relationship between the number of CCEs and a coding rate provided by CCEs.

Control information transmitted through a PDCCH is called Downlink Control Information (DCI). DCI can include the resource allocation of a PDSCH (also called a downlink (DL) grant)), the resource allocation of a PUSCH (also called an uplink (UL) grant), a set of transmit power control commands for pieces of UE within a specific UE group, and/or the activation of a Voice over Internet Protocol (VoIP).

Several layers are present in the second layer. First, a Medium Access Control (MAC) layer functions to map various logical channels to various transport channels and also plays a role of logical channel multiplexing for mapping multiple logical channels to one transport channel. The MAC layer is connected to a Radio Link Control (RLC) layer, that is, a higher layer, through a logical channel. The logical channel is basically divided into a control channel through which information of the control plane is transmitted and a traffic channel through which information of the user plane is transmitted depending on the type of transmitted information.

The RLC layer of the second layer functions to control a data size that is suitable for sending, by a lower layer, data received from a higher layer in a radio section by segmenting and concatenating the data. Furthermore, in order to guarantee various types of QoS required by radio bearers, the RLC layer provides three types of operation modes: a Transparent Mode (TM), an Un-acknowledged Mode (UM), and an Acknowledged Mode (AM). In particular, AM RLC performs a retransmission function through an Automatic Repeat and Request (ARQ) function for reliable data transmission.

The Packet Data Convergence Protocol (PDCP) layer of the second layer performs a header compression function for reducing the size of an IP packet header containing control information that is relatively large in size and unnecessary in order to efficiently send an IP packet, such as IPv4 or IPv6, in a radio section having a small bandwidth when sending the IP packet. Accordingly, transmission efficiency of the radio section can be increased because only essential information is transmitted in the header part of data. Furthermore, in an LTE system, the PDCP layer also performs a security function. The security function includes ciphering for preventing the interception of data by a third party and integrity protection for preventing the manipulation of data by a third party.

A Radio Resource Control (RRC) layer at the highest place of the third layer is defined only in the control plane and is responsible for control of logical channels, transport channels, and physical channels in relation to the configuration, re-configuration, and release of Radio Bearers (RBs). Here, the RB means service provided by the second layer in order to transfer data between UE and an E-UTRAN.

If an RRC connection is present between the RRC layer of UE and the RRC layer of a wireless network, the UE is in an RRC_CONNECTED state. If not, the UE is in an RRC_IDLE state.

An RRC state and an RRC connection method of UE are described below. The RRC state means whether or not the RRC layer of UE has been logically connected to the RRC layer of an E-UTRAN. If the RRC layer of UE is logically connected to the RRC layer of an E-UTRAN, it is called the RRC_CONNECTED state. If the RRC layer of UE is not logically connected to the RRC layer of an E-UTRAN, it is called the RRC_IDLE state. Since UE in the RRC_CONNECTED state has an RRC connection, an E-UTRAN can check the existence of the UE in a cell unit, and thus control the UE effectively. In contrast, if UE is in the RRC_IDLE state, an E-UTRAN cannot check the existence of the UE, and a core network is managed in a Tracking Area (TA) unit, that is, an area unit greater than a cell. That is, only the existence of UE in the RRC_IDLE state is checked in an area unit greater than a cell. In such a case, the UE needs to shift to the RRC_CONNECTED state in order to be provided with common mobile communication service, such as voice or data. Each TA is classified through Tracking Area Identity (TAI). UE can configure TAI through Tracking Area Code (TAC), that is, information broadcasted by a cell.

When a user first turns on the power of UE, the UE first searches for a proper cell, establishes an RRC connection in the corresponding cell, and registers information about the UE with a core network. Thereafter, the UE stays in the RRC_IDLE state. The UE in the RRC_IDLE state (re)selects a cell if necessary and checks system information or paging information. This process is called camp on. When the UE in the RRC_IDLE state needs to establish an RRC connection, the UE establishes an RRC connection with the RRC layer of an E-UTRAN through an RRC connection procedure and shifts to the RRC_CONNECTED state. A case where the UE in the RRC_IDLE state needs to establish with an RRC connection includes multiple cases. The multiple cases may include, for example, a case where UL data needs to be transmitted for a reason, such as a call attempt made by a user and a case where a response message needs to be transmitted in response to a paging message received from an E-UTRAN.

A Non-Access Stratum (NAS) layer placed over the RRC layer performs functions, such as session management and mobility management.

The NAS layer shown in FIG. 3 is described in detail below.

Evolved Session Management (ESM) belonging to the NAS layer performs functions, such as the management of default bearers and the management of dedicated bearers, and ESM is responsible for control that is necessary for UE to use PS service from a network. Default bearer resources are characterized in that they are allocated by a network when UE first accesses a specific Packet Data Network (PDN) or accesses a network. Here, the network allocates an IP address available for UE so that the UE can use data service and the QoS of a default bearer. LTE supports two types of bearers: a bearer having Guaranteed Bit Rate (GBR) QoS characteristic that guarantees a specific bandwidth for the transmission and reception of data and a non-GBR bearer having the best effort QoS characteristic without guaranteeing a bandwidth. A default bearer is assigned a non-GBR bearer, and a dedicated bearer may be assigned a bearer having a GBR or non-GBR QoS characteristic.

In a network, a bearer assigned to UE is called an Evolved Packet Service (EPS) bearer. When assigning an EPS bearer, a network assigns one ID. This is called an EPS bearer ID. One EPS bearer has QoS characteristics of a Maximum Bit Rate (MBR) and a Guaranteed Bit Rate (GBR) or an Aggregated Maximum Bit Rate (AMBR).

FIG. 5a is a flowchart illustrating a random access process in 3GPP LTE.

The random access process is used for UE 10 to obtain UL synchronization with a base station, that is, an eNodeB 20, or to be assigned UL radio resources.

The UE 10 receives a root index and a physical random access channel (PRACH) configuration index from the eNodeB 20. 64 candidate random access preambles defined by a Zadoff-Chu (ZC) sequence are present in each cell. The root index is a logical index that is used for the UE to generate the 64 candidate random access preambles.

The transmission of a random access preamble is limited to specific time and frequency resources in each cell. The PRACH configuration index indicates a specific subframe on which a random access preamble can be transmitted and a preamble format.

The UE 10 sends a randomly selected random access preamble to the eNodeB 20. Here, the UE 10 selects one of the 64 candidate random access preambles. Furthermore, the UE selects a subframe corresponding to the PRACH configuration index. The UE 10 sends the selected random access preamble in the selected subframe.

The eNodeB 20 that has received the random access preamble sends a Random Access Response (RAR) to the UE 10. The random access response is detected in two steps. First, the UE 10 detects a PDCCH masked with a random access-RNTI (RA-RNTI). The UE 10 receives a random access response within a Medium Access Control (MAC) Protocol Data Unit (PDU) on a PDSCH that is indicated by the detected PDCCH.

FIG. 5b illustrates a connection process in a radio resource control (RRC) layer.

FIG. 5b shows an RRC state depending on whether there is an RRC connection. The RRC state denotes whether the entity of the RRC layer of UE 10 is in logical connection with the entity of the RRC layer of eNodeB 20, and if yes, it is referred to as RRC connected state, and if no as RRC idle state.

In the connected state, UE 10 has an RRC connection, and thus, the E-UTRAN may grasp the presence of the UE on a cell basis and may thus effectively control UE 10. In contrast, UE 10 in the idle state cannot grasp eNodeB 20 and is managed by a core network on the basis of a tracking area that is larger than a cell. The tracking area is a set of cells. That is, UE 10 in the idle state is grasped for its presence only on a larger area basis, and the UE should switch to the connected state to receive a typical mobile communication service such as voice or data service.

When the user turns on UE 10, UE 10 searches for a proper cell and stays in idle state in the cell. UE 10, when required, establishes an RRC connection with the RRC layer of eNodeB 20 through an RRC connection procedure and transits to the RRC connected state.

There are a number of situations where the UE staying in the idle state needs to establish an RRC connection, for example, when the user attempts to call or when uplink data transmission is needed, or when transmitting a message responsive to reception of a paging message from the EUTRAN.

In order for the idle UE 10 to be RRC connected with eNodeB 20, UE 10 needs to perform the RRC connection procedure as described above. The RRC connection procedure generally comes with the process in which UE 10 transmits an RRC connection request message to eNodeB 20, the process in which eNodeB 20 transmits an RRC connection setup message to UE 10, and the process in which UE 10 transmits an RRC connection setup complete message to eNodeB 20. The processes are described in further detail with reference to FIG. 6.

1) The idle UE 10, when attempting to establish an RRC connection, e.g., for attempting to call or transmit data or responding to paging from eNodeB 20, sends an RRC connection request message to eNodeB 20.

2) When receiving the RRC connection message from UE 10, eNodeB 20 accepts the RRC connection request from UE 10 if there are enough radio resources, and eNodeB 20 sends a response message, RRC connection setup message, to UE 10.

3) When receiving the RRC connection setup message, UE 10 transmits an RRC connection setup complete message to eNodeB 20. If UE 10 successfully transmits the RRC connection setup message, UE 10 happens to establish an RRC connection with eNodeB 20 and switches to the RRC connected state.

Meanwhile, with an explosive increase in data in recent years, a 3GPP access of a mobile communication operator is becoming more congested. As a way of solving this problem, there is an attempt to offload data of a user equipment (UE) through a WLAN which is a non-3GPP access. Hereinafter, an architecture for connecting the WLAN to an EPC is described.

FIG. 6a and FIG. 6b illustrate an architecture for connecting a WLAN to an EPC.

FIG. 6a illustrates an architecture in which a WLAN is connected to a P-GW through an S2a interface. As can be seen with reference to FIG. 6a, a WLAN access network (in particular, it is a trusted WLAN access network since the S2a interface is an interface for connecting a trusted non-3GPP access to the EPC) is connected to the P-GW through the S2a interface. The content disclosed in TS 23.402 is incorporated herein by reference for an architecture for a trusted WLAN access network (TWAN).

FIG. 6b illustrates an architecture in which a WLAN is connected to a P-GW through an S2b interface. As can be seen with reference to FIG. 6b, a WLAN access network (in particular, it is an untrusted WLAN access network since the S2b interface is an interface for connecting an untrusted non-3GPP access to the EPC) is connected to the P-GW through an evolved packet data gateway (ePDG) connected to the P-GW through the S2b interface.

Hereinafter, a trusted WLAN and an untrusted WLAN may be both referred to as a WLAN.

Meanwhile, with a trend for offloading data of a UE not through a 3GPP access of an operator but through a WLAN which is a non-3GPP access, a technology such as IP flow mobility and seamless offload (IFOM), multi access PDN connectivity (MAPCON), or the like has been proposed to support a multiple radio access. The MAPCON technology is a technology of transmitting data by using a 3GPP access and a Wi-Fi access through respective PDN connections. The IFOM technology is a technology of transmitting data by aggregating the 3GPP access and the Wi-Fi access to one PDN or P-GW.

FIG. 7a is an exemplary diagram of the IFOM technology.

Referring to FIG. 7a, the IFOM technology is to provide the same PDN connection through several pieces of different access. Such IFOM technology provides seamless offloading onto a WLAN.

Furthermore, the IFOM technology provides the transfer of IP flows having the same one PDN connection from one access to the other access.

FIG. 7b is an exemplary diagram of the MAPCON technology.

As can be seen with reference to FIG. 7b, the MAPCON technology is to connect several PDN connections, easily, IP flows to other APNs through another access system.

In accordance with such MAPCON technology, the UE 10 can generate a new PDN connection on access that has not been used before. Alternatively, the UE 10 can generate a new PDN connection in one of several pieces of access that were used before. Alternatively, the UE 10 may transfer some of or all PDN connections to another access.

As described above, with the help of the technologies capable of offloading the traffic of UE onto a WLAN, the congestion of the core network of a mobile communication service provider can be reduced.

The provider provides a policy to the UE in order to divert the traffic onto a general data communication network and the UE may divert data thereof onto the wireless LAN according to the policy.

In order to provision the policy the UE, a 3GPP based access network discovery and selection function (ANDSF) is enhanced to provide a policy associated with the wireless LAN.

FIGS. 8a and 8b show network control entities for selecting an access network.

As can be seen with reference to FIG. 8a, the ANDSF may be present in the home network (Home Public Land Mobile Network (hereinafter called ‘HPLMN’)) of the UE 10. Furthermore, as can be seen with reference to FIG. 8b, the ANDSF may also be present in the Visited Public Land Mobile Network (hereinafter called ‘VPLMN’) of the UE 10. When the ANDSF is present in a home network as described above, it may be called an H-ANDSF 61. When the ANDSF is present in a visited network, it may be called a V-ANDSF 62. Hereinafter, the ANDSF 60 generally refers to the H-ANDSF 61 or the V-ANDSF 62.

The ANDSF can provide information about an inter-system movement policy, information for access network search, and information about inter-system routing, for example, a routing rule.

As described above, the IFOM is performed based on a decision primarily made by the UE, and uses a dual stack mobile IP (DSMIP) which is a host-based mobility protocol.

Meanwhile, a technology for providing the IFOM through the S2a and S2b interfaces using GTP or PMIP which is a network-based protocol is called a network based IP flow mobility (NBIFOM).

Here, as the UE and the network request the update of each routing rule, respectively, the update request of the routing rule may be repeated.

Further, the ping-pong of the IP flow between accesses may occur thereby.

### SUMMARY OF THE INVENTION

Accordingly, an object of the present invention is to present a method that can solve the aforementioned problem.

In an aspect, a method of updating a routing rule for moving a specific IP flow to a specific access is provided. The method includes receiving, by a user device, a update request message of a routing rule for NBIFOM (network-based IP flow mobility) initiated by a network wherein the update request message of the routing rule includes a routing rule for moving the specific IP flow of the user device from a first access to a second access and a timer value calculated by the network and wherein the timer value is calculated by the network based on one or more of subscriber information, load information and statistical information, transmitting, by the user device, an acceptance message for the update request of the routing rule to the network, and operating a timer according to the timer value wherein before the timer expires, the user device is not able to transmit the update request message of the routing rule in order to return the specific IP flow from the second access to the first access.

As the acceptance message is transmitted, the specific IP flow may be moved from the first access to the second access.

The update request message of the routing rule may include the timer value as an IP flow unit, a PDN connection unit, a user device unit or an access unit.

The timer value may be calculated by at least one of a difference between time allowable by subscriber information and current time, a time value set according to a network overload level recognizable in the network, and a statistical amount of an actually used traffic via a specific access.

If the timer expires, the method may further include reevaluating the routing rule and transmitting the update request message for the routing rule according a result of the reevaluation.

In another aspect, a user device for updating a routing rule in order to move a specific IP flow to a specific access is provided. The user device includes a receiving unit for receiving a update request message of a routing rule for NBIFOM (network-based IP flow mobility) initiated by a network wherein the update request message of the routing rule includes a routing rule for moving the specific IP flow of the user device from a first access to a second access and a timer value calculated by the network and wherein the timer value is calculated by the network based on one or more of subscriber information, load information and statistical information, a transmitting unit for transmitting an acceptance message to the network by the update request of the routing rule, and a processor for operating a timer according to the timer value wherein before the timer expires, the user device is not able to transmit the update request message of the routing rule in order to return the specific IP flow from the second access to the first access.

According to the embodiment of the present disclosure, the aforementioned problem of the related art is solved.

In more detail, since the UE according to the disclosure of the present disclosure can directly or indirectly recognize a status of the network, the UE can try to effectively request a update of routing rule.

Also, according to the disclosure of the present disclosure, the IP flow ping-pong problem between accesses is solved.

### BRIEF DESCRIPTION OF THE DRAWINGS

FIG. 1 is a structural diagram of an evolved mobile communication network.

FIG. 2 is an exemplary diagram illustrating architectures of a general E-UTRAN and a general EPC.

FIG. 3 is an exemplary diagram illustrating a structure of a radio interface protocol on a control plane between UE and eNodeB.

FIG. 4 is another exemplary diagram illustrating a structure of a radio interface protocol on a user plane between the UE and a base station.

FIG. 5a is a flowchart illustrating a random access process in 3GPP LTE.

FIG. 5b illustrates a connection process in a radio resource control (RRC) layer.

FIG. 6a and FIG. 6b illustrate an architecture for connecting a WLAN to an EPC.

FIG. 7a is an exemplary diagram of the IFOM technology, and FIG. 7b is an examplary diagram of the MAPCON technology.

FIGS. 8a and 8b illustrate a network control entity for selecting an access network.

FIG. 9a illustrates an example that a newly defined RAN support parameter (RAN rule) as well as ANDSF policy is provided to the UE.

FIG. 9b is a diagram specifically illustrating a procedure of providing the RAN support parameter (RAN rule) of FIG. 9a to the UE.

FIG. 10 illustrates an example that NBIFOM function is discovered/negotiated during a PDN connection establishment procedure.

FIG. 11 illustrates a process of delivering an update of a routing rule for NBIFOM.

FIGS. 12a to 12c illustrate a problem which may be generated as NBIFOM started by the UE and NIBIFOM started by the network are independently attempted.

FIG. 13 is a flowchart illustrating a ping-pong problem which may be generated as NBIFOM started by the UE and NIBIFOM started by the network are independently attempted.

FIGS. 14a and 14b are flowcharts illustrating the operation according to the first suggestion of the first disclosure.

FIG. 15 is a flowchart illustrating the operation according to the second suggestion of the first disclosure.

FIG. 16a is a flowchart illustrating the operation of the network according to the second disclosure of the present specification.

FIG. 16b is a flowchart illustrating the operation of the network according to the second disclosure of the present specification.

FIG. 17 is a block diagram of UE 100 and P-GW 530 according to an embodiment of the present invention.

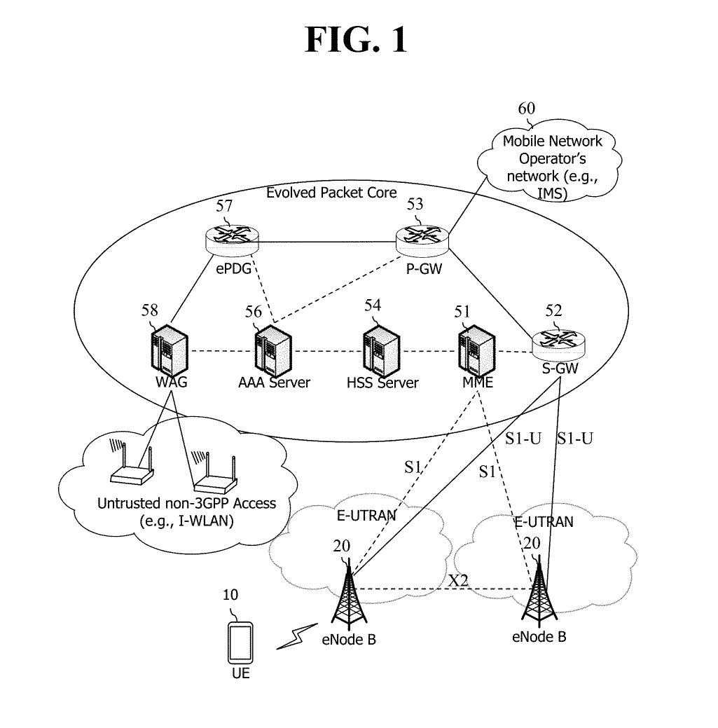

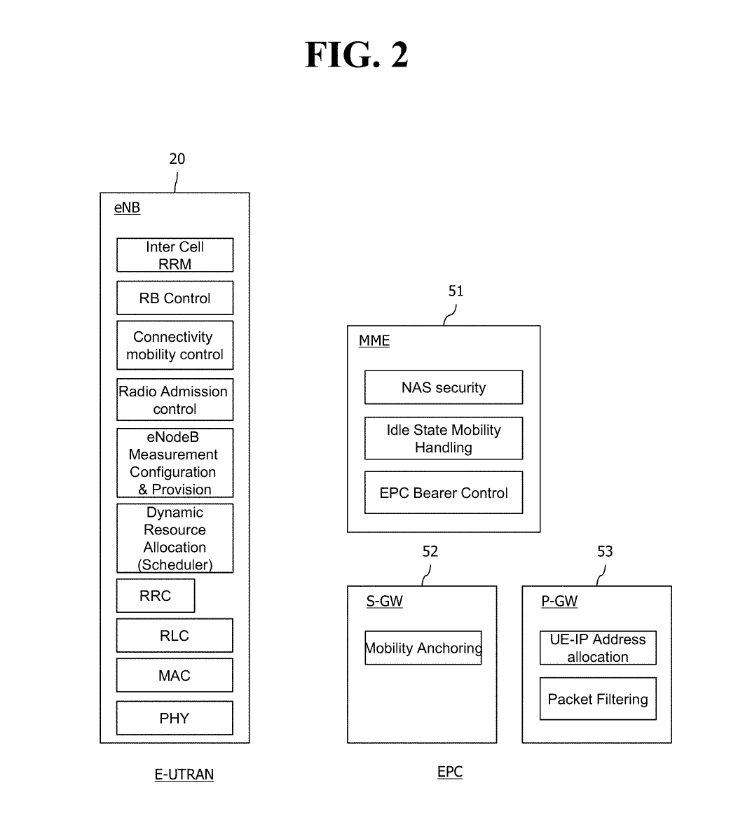

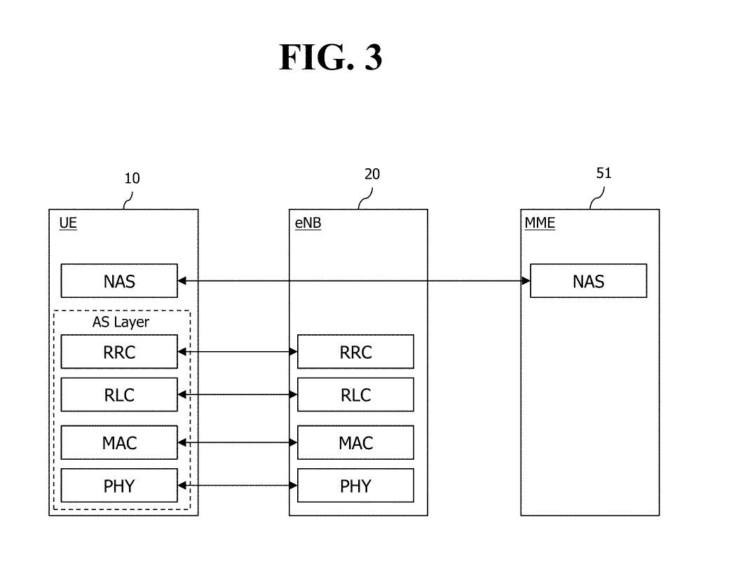

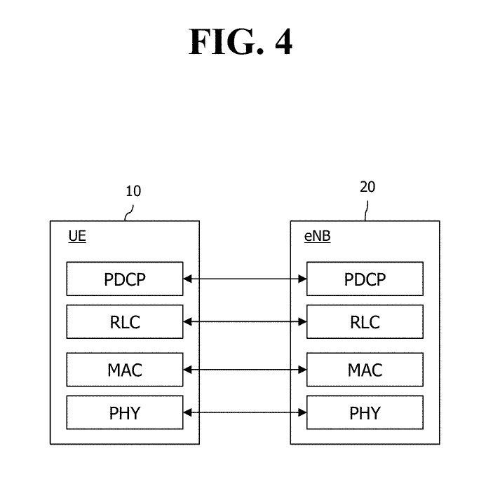

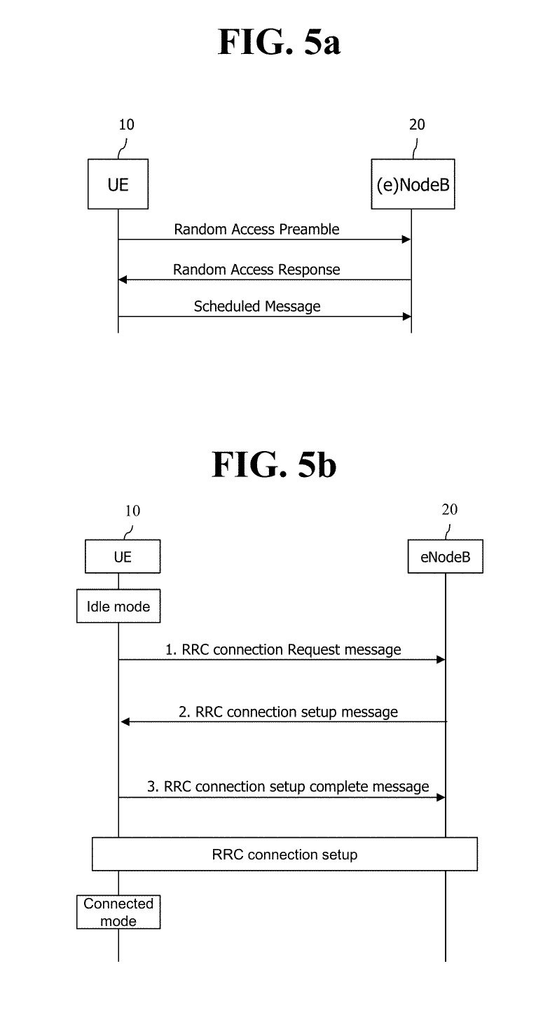

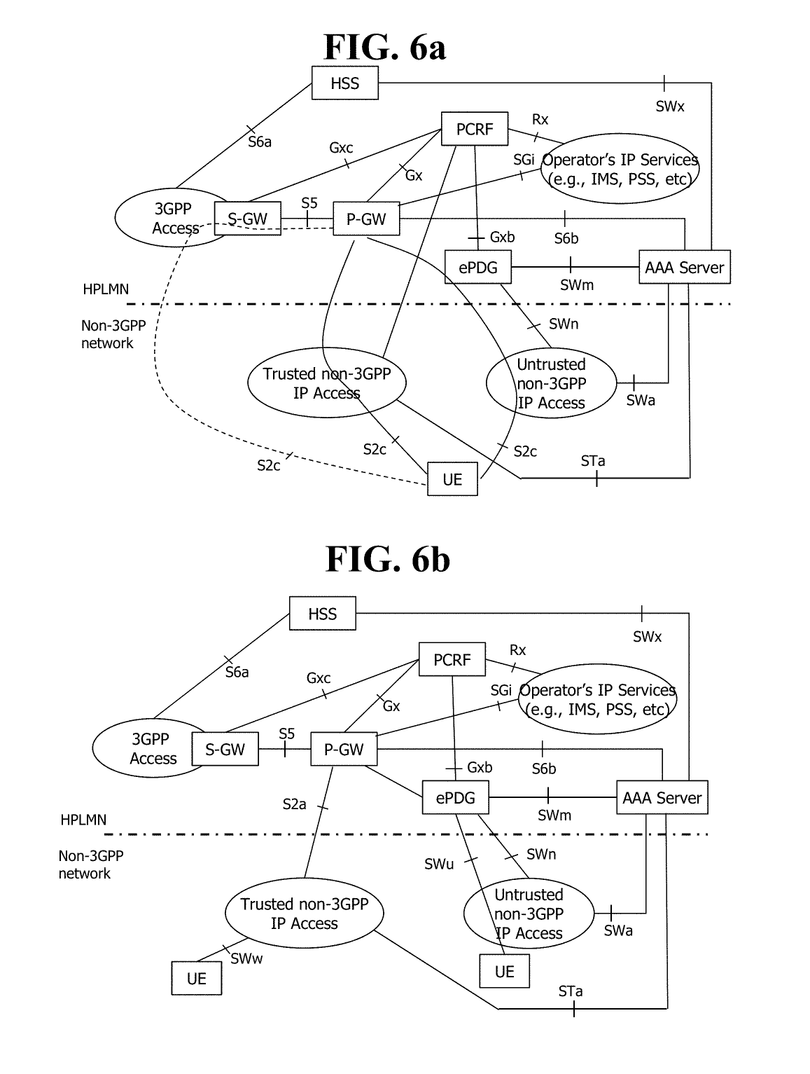

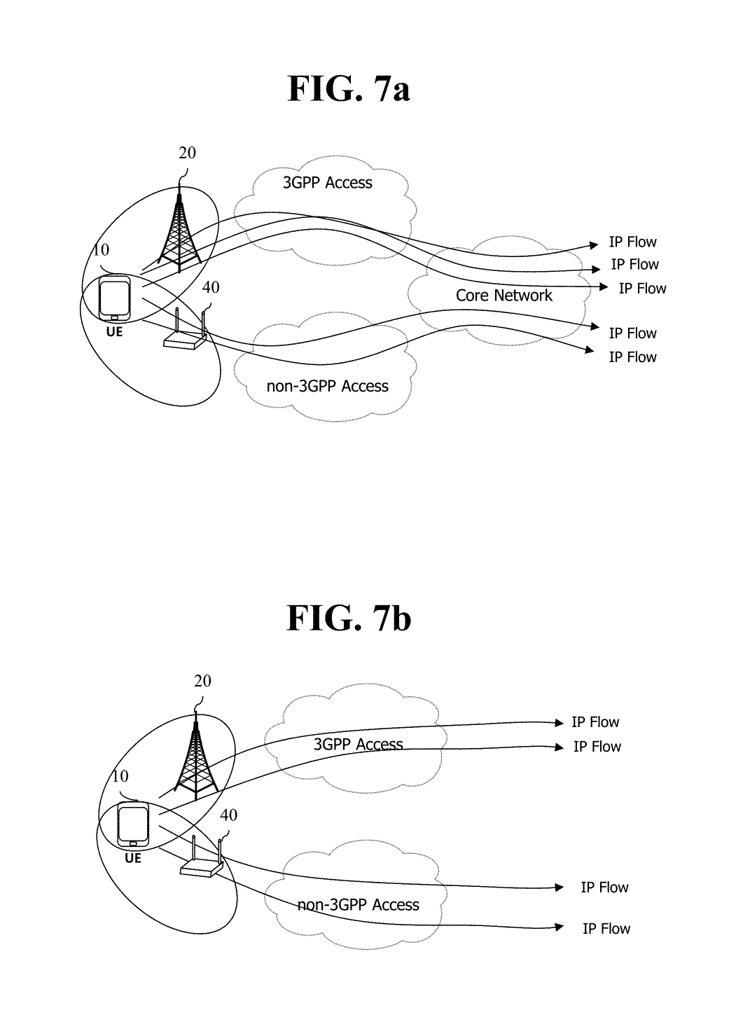

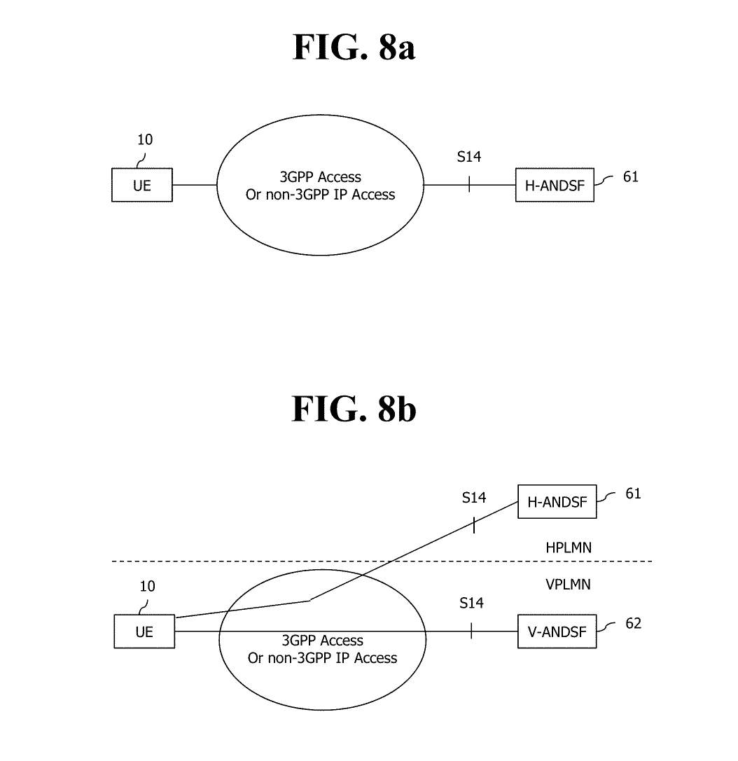

### DESCRIPTION OF EXEMPLARY EMBODIMENTS

The present invention is described in light of UMTS (Universal Mobile Telecommunication System) and EPC (Evolved Packet Core), but not limited to such communication systems, and may be rather applicable to all communication systems and methods to which the technical spirit of the present invention may apply.

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

In the drawings, user equipments (UEs) are shown for example. The UE may also be denoted a terminal or mobile equipment (ME). The UE may be a laptop computer, a mobile phone, a PDA, a smartphone, a multimedia device, or other portable device, or may be a stationary device such as a PC or a car mounted device.

### Definition of Terms

For a better understanding, the terms used herein are briefly defined before going to the detailed description of the invention with reference to the accompanying drawings.

A GERAN is an abbreviation of a GSM EDGE Radio Access Network, and it refers to a radio access section that connects a core network and UE by GSM/EDGE.

A UTRAN is an abbreviation of a Universal Terrestrial Radio Access Network, and it refers to a radio access section that connects the core network of the 3rd generation mobile communication and UE.

An E-UTRAN is an abbreviation of an Evolved Universal Terrestrial Radio Access Network, and it refers to a radio access section that connects the core network of the 4th generation mobile communication, that is, LTE, and UE.

An UMTS is an abbreviation of a Universal Mobile Telecommunication System, and it refers to the core network of the 3rd generation mobile communication.

UE or an MS is an abbreviation of User Equipment or a Mobile Station, and it refers to a terminal device.

An EPS is an abbreviation of an Evolved Packet System, and it refers to a core network supporting a Long Term Evolution (LTE) network and to a network evolved from an UMTS.

A PDN is an abbreviation of a Public Data Network, and it refers to an independent network where a service for providing service is placed.

A PDN connection refers to a connection from UE to a PDN, that is, an association (or connection) between UE represented by an IP address and a PDN represented by an APN.

A PDN-GW is an abbreviation of a Packet Data Network Gateway, and it refers to a network node of an EPS network which performs functions, such as the allocation of a UE IP address, packet screening & filtering, and the collection of charging data.

A Serving gateway (Serving GW) is a network node of an EPS network which performs functions, such as mobility anchor, packet routing, idle mode packet buffering, and triggering an MME to page UE.

A Policy and Charging Rule Function (PCRF) is a node of an EPS network which performs different QoS for each service flow and a policy decision for dynamically applying a charging policy.

An Access Point Name (APN) is the name of an access point that is managed in a network and provides to UE. That is, an APN is a character string that denotes or identifies a PDN. Requested service or a network (PDN) is accessed via a P-GW. An APN is a name (character string, e.g., ‘internet.mnc012.mcc345.gprs’) previously defined within a network so that the P-GW can be searched for.

A Tunnel Endpoint Identifier (TEID) is an end point ID of a tunnel set up between nodes within a network and is set in each section as a bearer unit of each terminal.

A NodeB is an eNodeB of a UMTS network and installed outdoors. The cell coverage of the NodeB corresponds to a macro cell.

An eNodeB is an eNodeB of an Evolved Packet System (EPS) and is installed outdoors. The cell coverage of the eNodeB corresponds to a macro cell.

An (e)NodeB is a term that denotes a NodeB and an eNodeB.

An MME is an abbreviation of a Mobility Management Entity, and it functions to control each entity within an EPS in order to provide a session and mobility for UE.

A session is a passage for data transmission, and a unit thereof may be a PDN, a bearer, or an IP flow unit. The units may be classified into a unit of the entire target network (i.e., an APN or PDN unit) as defined in 3GPP, a unit (i.e., a bearer unit) classified based on QoS within the entire target network, and a destination IP address unit.

A PDN connection is a connection from UE to a PDN, that is, an association (or connection) between UE represented by an IP address and a PDN represented by an APN. It means a connection between entities (i.e., UE-PDN GW) within a core network so that a session can be formed.

UE context is information about the situation of UE which is used to manage the UE in a network, that is, situation information including an UE ID, mobility (e.g., a current location), and the attributes of a session (e.g., QoS and priority)

A Non-Access-Stratum (NAS) is a higher stratum of a control plane between UE and an MME. The NAS supports mobility management and session management between UE and a network, IP address maintenance, and so on.

RAT is an abbreviation of Radio Access Technology, and it means a GERAN, a UTRAN, or an E-UTRAN.

Local Operating Environment Information: This is a set of implementation specific parameters which describe the local environment in which the UE is operating.

Presence Reporting Area: This is an area defined to report the presence of a UE in a 3GPP packet domain for the reasons of policy control and/or accounting or the like. In case of E-UTRAN, the presence reporting area consists of adjacent or not-adjacent tracking areas or a set of eNodeBs and/or cells. There are two types of presence reporting areas. One is a UE-dedicated presence reporting area, and the other is a presence reporting area predetermined by a core network.

ANDSF (Access Network Discovery and Selection Function): This is one of network entities for providing a policy for discovering and selecting an access that can be used by a UE on an operator basis.

ISRP (Inter-System Routing Policy): This is a rule defined by the operator to indicate which one will be used by the UE for routing of IP traffic among several radio access interfaces. The ISRP may include three types of rules as follows, as a policy for defining an access network preferred (i.e., having a high priority) or restricted to route/steer a packet service (or an IP flow or IP traffic or applications). That is, the ISRP may be divided into an IP flow mobility (IFOM) rule, a multi access PDN connectivity (MAPCON) rule, and a non-seamless WLAN offload (NSWO) rule as follows.
IFOM (IP Flow Mobility) rule: This rule is in regards to a list in which access technologies/access networks to be used by the UE are arranged according to a priority, when traffic matched to a specific IP traffic filter can be routed on a specific APN or on any APN. Further, this rule may designate for which radio access the traffic matched to the specific IP traffic filter is limited on the specific APN or on the any APN.
MAPCON (Multi Access PDN Connectivity) rule: This rule is a list in which the access technologies/access networks to be used by the UE are arranged according to the priority when a PDN connection for the specific APN can be routed. Further, this rule may designate for which radio access a PDN connection to a specific APN will be limited.
NSWO(Non-seamless WLAN offload) rule: This rule designates whether certain traffic will be offloaded or not offloaded non-seamlessly to a WLAN.

ISMP (Inter-System Mobility Policy): This is a set of rules defined by an operator to have an impact on an inter-system mobility decision made by the UE. When the UE can route IP traffic on a single radio access interface, the UE may use ISMP to select the most appropriate access technology type or access network in a given time.

RAN rule: This is to evaluate an RAN rule programmed in the UE and having radio access network (RAN) assistance parameters received from the network. The RAN rule is also called WLAN interworking supported by the RAN used without ANDSF ISRP/ISMP. When the RAN rule for moving traffic to the WLAN is satisfied, an access stratum (AS) layer of the UE delivers a move-traffic-to-WLAN indication and a WLAN identifier together to a higher layer of the UE. In this case, the UE selects the WLAN and moves all offloadable PDN connections to the WLAN. Alternatively, when the RAN rule for moving the traffic to the 3GPP access is satisfied, the AS layer of the UE delivers a move-traffic-from-WLAN indication to the higher layer of the UE. In this case, the UE moves all PDN connections on the WLAN through 3GPP. 3GPP TS 23.401, TS 23.060, TS 23.402, TS 36.300, TS 36.304, TS 36.331, TS 25.304, and TS 25.331 may be incorporated herein by reference to know detailed descriptions on the RAN rule.

Multi-access PDN connection: This is a PDN connection in which traffic can be routed to the 3GPP access and/or the WLAN access. Each IP flow is routed only to one access at one instance.

<RAN Support Parameter>

Recently, aside from the policy provided by ANDSF, there has been discussion to determine the policy of the detour to WLAN by the mobile communication service providers. In such a situation, recently, RAN support parameter has been suggested.

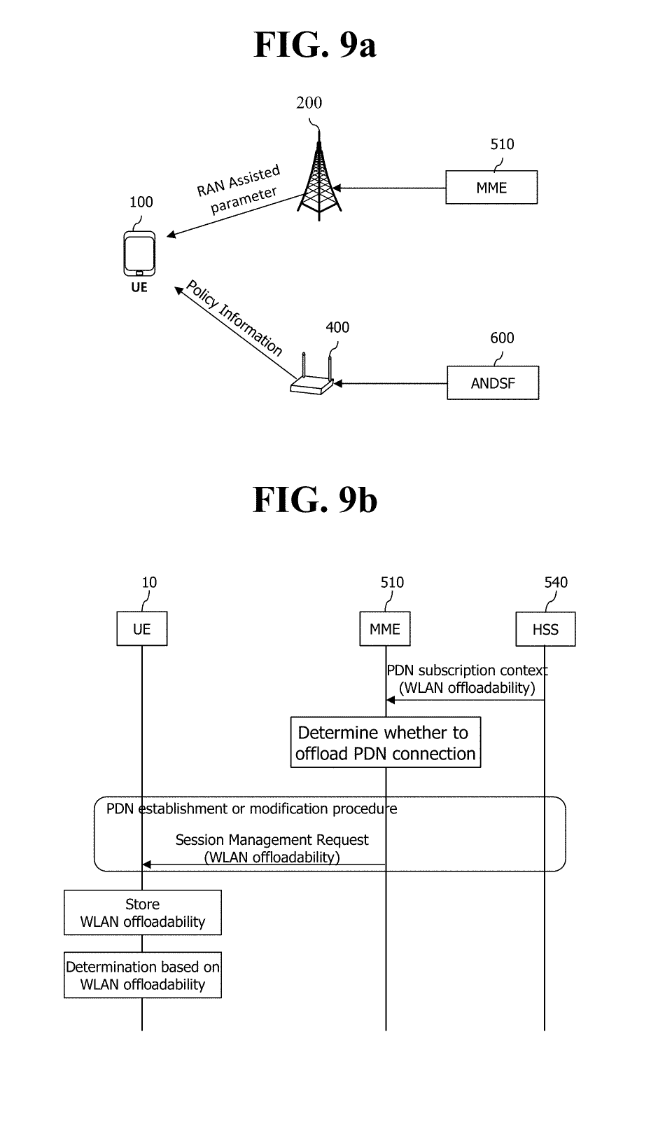

FIG. 9a illustrates an example that a newly defined RAN support parameter (RAN rule) as well as ANDSF policy is provided to the UE.

As illustrated in FIG. 9a, an ADNSF 600 may provide policy information to a UE 100, but the eNodeB 200 of E-UTRAN (or UTRAN) may provide a newly defined RAN (radio access network) support parameter to the UE 100.

The RAN support parameter may be transmitted through a RRC signaling. The RAN support parameter may include a threshold for the intensity and quality of E-UTRAN signal, a threshold for the rate of use of WLAN channel, a threshold for the transmission rate of WLAN backhaul data, the list of WLAN identifier, and OPI (offload preference indicator). The UE may use the RAN support parameter for access network selection between 3GPP access and WLAN access and the routing of traffic.

For the routing of the traffic, the MME may deliver, to UE, information indicating which PDN connection may be detoured to WLAN and information indicating which PDN connection cannot be detoured to WLAN.

Meanwhile, the subscriber information within HSS may include indication about whether WLAN offloading is allowed or prohibited for specific PDN so that the service provider may allow or prohibit WLAN offloading per user or per APN.

The MME may determine whether to allow WLAN offloading for the UE and PDN connection as follows.
MME determines offloadability for the PDN connection based on subscriber information and internally-set policy.
When UE establishes a new PDN connection, the MME may indicate whether WLAN offloading of the PDN connection is possible.
MME may provide update indication of WLAN offloadability for PDN connection to the UE. This may be initiated through the insert subscriber data procedure of the HSS. Further, this may also be initiated through the bearer modification procedure.

The UE may consider WLAN offloadability information provided from the MME when performing traffic offloading/handover between the 3GPP access and the WLAN access.

When the UE receives WLAN offloadability indication for the PDN connection, the UE stores the indication while the PDN connection is maintained and performs the update when a new indication is received.

Meanwhile, the indication on whether the PDN connection may be offloaded to the WLAN is delivered from the source MME to the target MME during the mobility management procedure. This allows the target MME to learn from the indication provided to the UE, through which the updated indication may be provided the UE.

FIG. 9b is a diagram specifically illustrating a procedure of providing the RAN support parameter (RAN rule) of FIG. 9a to the UE.

AS shown with reference to FIG. 9b, the HSS 540 may deliver WLAN offloadability to the MME 510 as shown in Table 2 below. The WLAN offloadability may be delivered through the PDN subscriber context illustrated in FIG. 9b but may also be transmitted to the MME during the location update procedure.

TABLE 2

| | |
|---|---|
| WLAN | This indicates whether traffic related to the APN may be |
| offloadability | offloaded to WLAN or should be maintained on the |
| | 3GPP access. |

Then the MME 510 determines whether to offload the PDN connection based on the WLAN offloadability delivered from the HSS.

Further, the MME 510 may deliver the WLAN offloadability indication to the UE 100 during the PDN establishment procedure or modification procedure.

<NBIFOM (Network Based IP Flow Mobility)>

Meanwhile, the technology of providing IFOM through S2a and S2b interfaces which use GTP to PMIP which are network-based protocols is called NBIFOM (network based IP flow mobility). Such an NBIFOM supports 3GPP access and WLAN access by the UE. Such an NBIFOM may be divided into UE-initiated NBIFOM and network-initiated NBIFOM.

UE-initiated NBIFOM: UE-desired Mapping between IP flows and access links may be provided to PGW. In this case, the network may only accept or reject IP flow movement of the UE and cannot initiate IP flow movement.

Network-initiated NBIFOM: Network-desired mapping between IP flows and access links may be provided to the UE. In this case, the UE may only accept or reject the IP flow movement, but the UE′cannot initiate IP flow movement.

The NBIFOM function is activated only when supported by both the UE and the network. Hence, the detection/negotiation process for the NBIFOM is necessary.

Specifically, the UE delivers the NBIFOM function indication to the network during the first PDN connection establishment procedure. When the network supports the NBIFOM function, P-GW 530 confirms NBIFOM support.

A more specific procedure will be described with reference to the drawings.

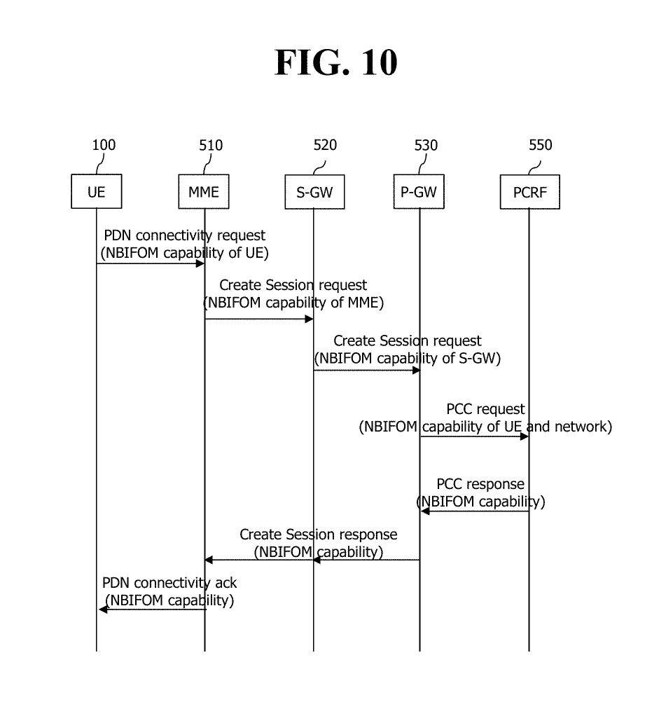

FIG. 10 illustrates an example that NBIFOM function is discovered/negotiated during a PDN connection establishment procedure.

As shown in FIG. 10, the UE 100 enables NBIFOM function indication to be included in the PDN connectivity request message and transmits the PDN connectivity request message.

The MME 510 and the S-GW 520 transmit the session generation request message including their own NBIFOM function indication.

While IP-CAN session is established, the P-GW 530 transmits PCC request message including NBIFOM function indication and RAT type of the UE and the P-GW to the PCRF 600.

Then the PCRF 600 delivers PCC response message including decision on whether to use NBIFOM in the corresponding PDN setting to the P-GW 530 based on the NBIFOM function of the PCRF 600 and the indication of the UE and another network node.

Then the P-GW 530 enables the NBIFOM function indication to be included in the session generation response message and delivers the session generation response message to the MME 510. Then the MME 510 delivers the PDN connection confirmation message to the UE 100.

Meanwhile, when the routing rule for the NBIFOM is updated, the PCRF 600 may deliver to the UE 100 via the P-GW 530, which will be described with reference to the drawings below.

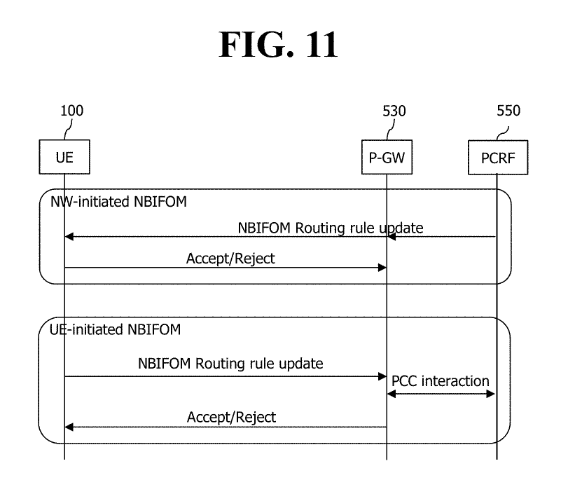

FIG. 11 illustrates a process of delivering an update of a routing rule for NBIFOM.

As shown in FIG. 11, the delivery of the updated routing rule may be different depending on whether the network initiates NBIFOM or the UE initiates NBIFOM.

First, in the case of the NBIFOM initiated by the network, the PCRF 600 may trigger the update of the routing rule for the NBIFOM, and such an updated routing rule may be delivered to the P-GW 530 during the session modification procedure.

The P-GW 530 delivers the routing rule to the UE 100 via S-GW 520 and MME 510. Specifically, when the P-GW 530 receives the policy about the routing rule update from the PCRF 600 and the corresponding PDN connection is routed with both the 3GPP and the WLAN access, the P-GW 530 may deliver the routing rule on the 3GPP access and the WLAN access.

In this case, the UE 100 may accept/reject the update routing rule. Hence, the P-GW 530 may not apply the updated routing rule until the confirmation of the UE 100.

Meanwhile, in the case of the NBIFOM initiated by the UE, the UE 100 delivers the updated routing rule to the P-GW 530. Specifically, when the corresponding PDN connection is routed with both the 3GPP and WLAN access, the UE 100 may deliver the routing rule on the 3GPP access and the WLAN access.

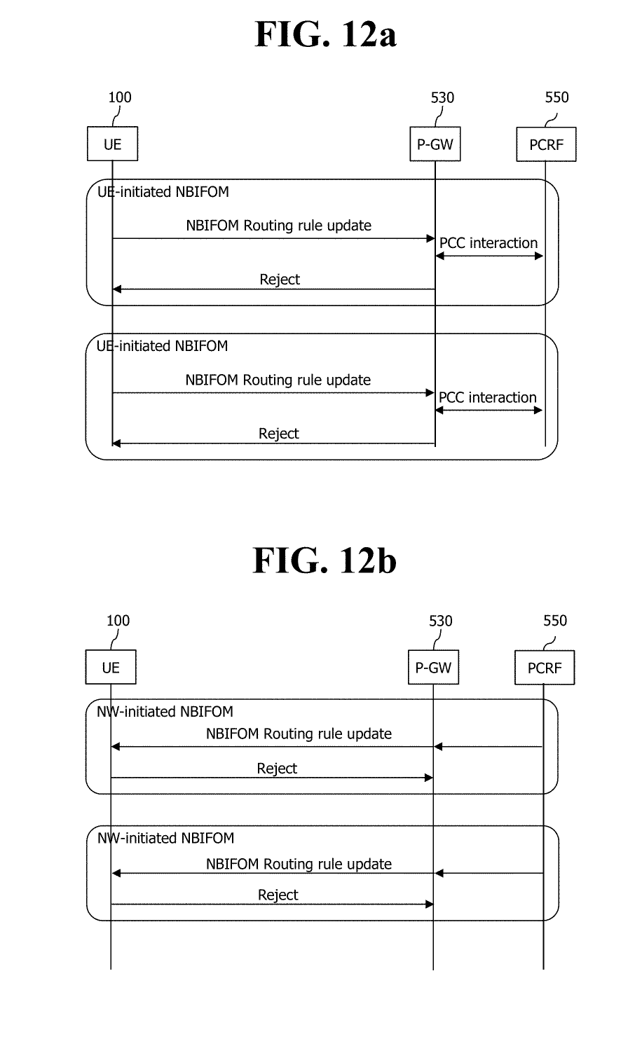

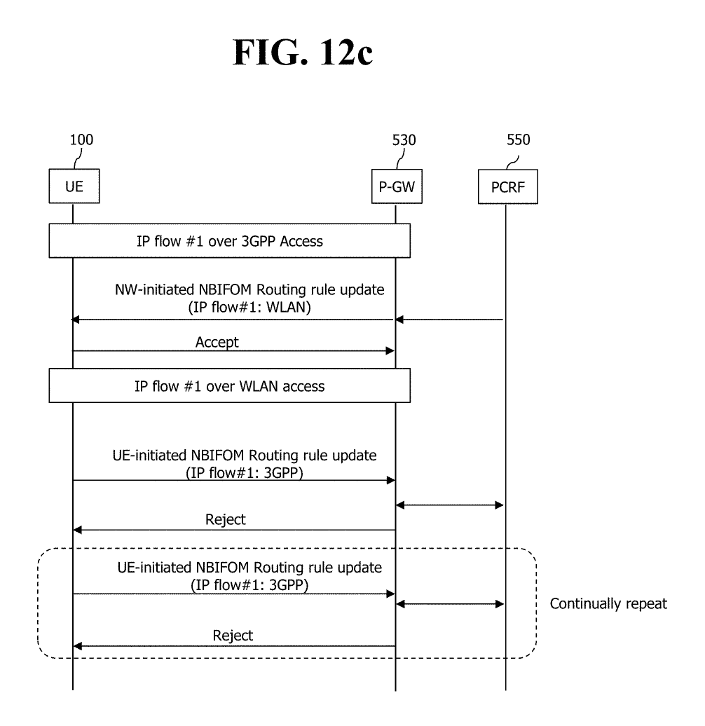

However, there is a problem that an unnecessary signal may be generated as ten NBIFOM initiated by the UE and the NBIFOM initiated by the network are independently attempted, which will be described below with reference to FIGS. 12a to 12c.

FIGS. 12a to 12c illustrate a problem which may be generated as NBIFOM started by the UE and NIBIFOM started by the network are independently attempted.

First, referring to FIG. 12a, the UE 100 requests the routing rule update to the network, e.g., P-GW 530 in order to hand the IP flow over to the WLAN or 3GPP access.

Yet, the request of the UE 100 is rejected for several reasons (e.g., with the issue of the load situation of the access, the policy, charging fee, the access of the amount of use, etc.).

However, the UE does not know why the request of the UE 100 has been rejected, and thus the UE 100 may transmit the request of the routing rule update again.

Likewise, the waste of the network resource is generated by repetition of the same request.

In particular, the UE 100 may request the routing rule update anytime if the information known by the UE such as user preference, ADNSF rule, several 3GPP/WLAN interworking-related threshold values, etc. are satisfied, and thus this problem becomes more serious.

Likewise, it may be inefficient to continue the same request based only on the information known by the UE 100 without recognizing the network situation.

Next, referring to FIG. 12b, the network, for example, P-GW 530, requests the routing rule update to the UE 100 in order to hand the IP flow of the UE to WLAN or 3GPP access.

Yet, the UE 100 rejects the request for several reasons (e.g., user preference).

However, the network does not know the reason why the request of the network has been rejected, and thus the request of the routing rule update may be transmitted again.

Likewise, the network resource is wasted by such a continuous repetition of the same request.

Next, as shown in FIG. 12c, the UE 100 transmits and receives IP flow #1 on the 3GPP access.

At this time, the network requests the routing rule update which is the network-initiated NBIFOM in order to hand the IP flow #1 over to the WLAN access.

The UE 100 accepts the routing rule update request.

As such, the IP flow #1 is handed over to the WLAN access.

Yet, thereafter, if the information known by the UE, e.g., user preference, ANDSF rule, several 3GPP/WLAN interworking-related thresholds, etc. are satisfied, the UE 100 requests the routing rule update which is the UE-initiated NBIFOM in order to hand the IP flow #1 to the 3GPP.

However, the request of the UE 100 is rejected for several reasons (e.g., issues of the load situation of the access, policy, charging fee, the access of the amount of use, etc.).

However, the UE 100 does not know why the request of the UE 100 has been rejected, and thus the UE 100 can transmit the request of the routing rule update again.

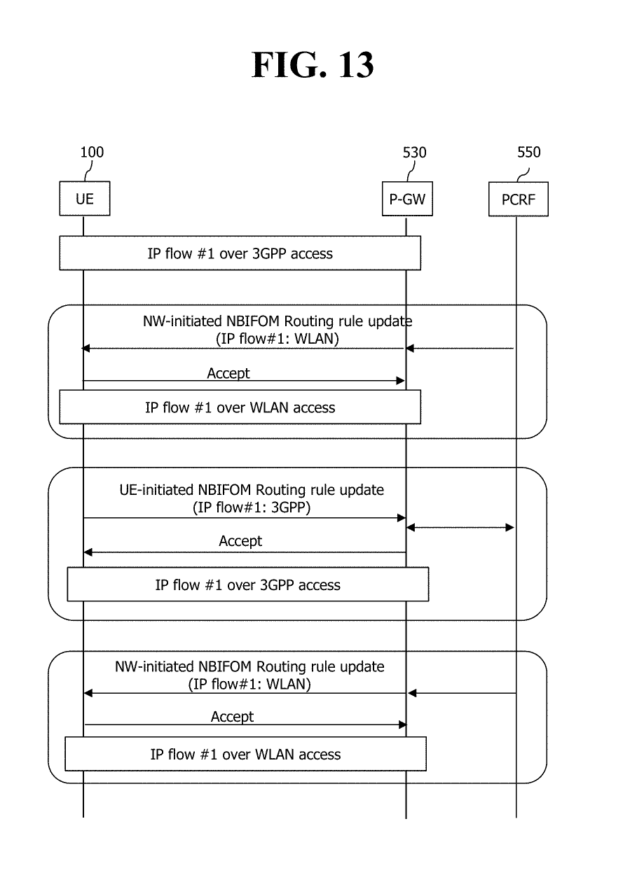

Meanwhile, the ping-pong problem may occur as the UE-initiated NBIFOM and the network-initiated NBIFOM are independently attempted, which will be described below with reference to FIG. 13.

FIG. 13 is a flowchart illustrating a ping-pong problem which may be generated as NBIFOM started by the UE and NIBIFOM started by the network are independently attempted.

As known with reference to FIG. 13, the UE 100 transmits and receives IP flow #1 on the 3GPP access.

At this time, the network requests the routing rule update which is the network-initiated NBIFOM in order to hand the IP flow #1 to the WLAN access.

The UE 100 accepts the routing rule update request.

As such, the IP flow #1 is handed over to the WLAN access.

Yet, thereafter, if the information known by the UE, e.g., user preference, ANDSF rule, several 3GPP/WLAN interworking-related thresholds, etc. are satisfied, the UE 100 requests the routing rule update which is the UE-initiated NBIFOM in order to hand the IP flow #1 to the 3GPP.

The P-GW 530 accepts the routing rule update request.

As such, the IP flow #1 is handed over to the 3GPP access.

Yet, the network may request the routing rule update which is the network-initiated NBIFOM again in order to hand the IP flow #1 to the WLAN access based on another information as well as information known by the UE.

Likewise, the ping-pong of IP flow #1 may occur between the 3GPP access and the WLAN access as the UE-initiated NBIFOM and the network-initiated NBIFOM are independently attempted.

<Disclosure of the Present Specification>

Hence, the present specification proposes a mechanism which allows a dual mode UE supporting both the cellular access and the WLAN access to efficiently perform the IP flow movement in a mobile communication system such as 3GPP GSM/UMTS/EPS (evolved packet system). The disclosure of the present specification includes the combination of one or more suggestions of the following.

I. First Disclosure of the Present Specification

The first disclosure of the present specification is as follows.

I-1. First Suggestion: Improvement on the Routing Rule Update of the Network

According to the first suggestion of the present specification, the routing rule update request which the network transmits in order to move the specific IP flow to the specific access network may include one of the following informations.

1) Reason of IP Flow Movement Request

2) Intensity of Routing Rule Update Request:

The intensity of the routing rule update request may be expressed as shall/should/may, etc. The intensity of such a request may implicitly include whether the UE 100 should certain accept or it is optional.

For example, whether the amount of use allowed of the user for a specific access is exceeded, the intensity such as “shall” may be included in the routing rule update request transmitted by the network.

3) Priority of the Routing Rule Update Request

The concept of the priority is similar to the concept of the intensity of the request. When the network transmits a plurality of routing rule update request messages for moving several PDN/IP flows, the relative priority order between request messages may be implicitly included.

4) Timer Value of Prohibiting IP-Flow Movement Request to Specific Access

Time value for blocking the attempt of the UE to return the specific IP flow to the 3GPP access even when the network has transmitted the routing rule of changing the specific IP flow from the 3GPP to the WLAN access.

Or time value for blocking the attempt of the UE to return the specific IP flow to the WLAN access even when the network has transmitted the routing rule of changing the specific IP flow from the WLAN to the 3GPP access.

The value of timer and specific access may have been explicitly mapped within the routing rule request message.

Basically, the granularity of the timer of prohibiting the same request has been described with the IP flow unit of updating the routing rule, but the network situation may have been included directly or indirectly, which may be applied to the several granularities and the combination thereof in an extended manner. Further, they may be individually operated.

i. IP flow

ii. PDN connection

iiia UE

iv. Access network

v. Group operated with the purpose of management in network or subscriber information

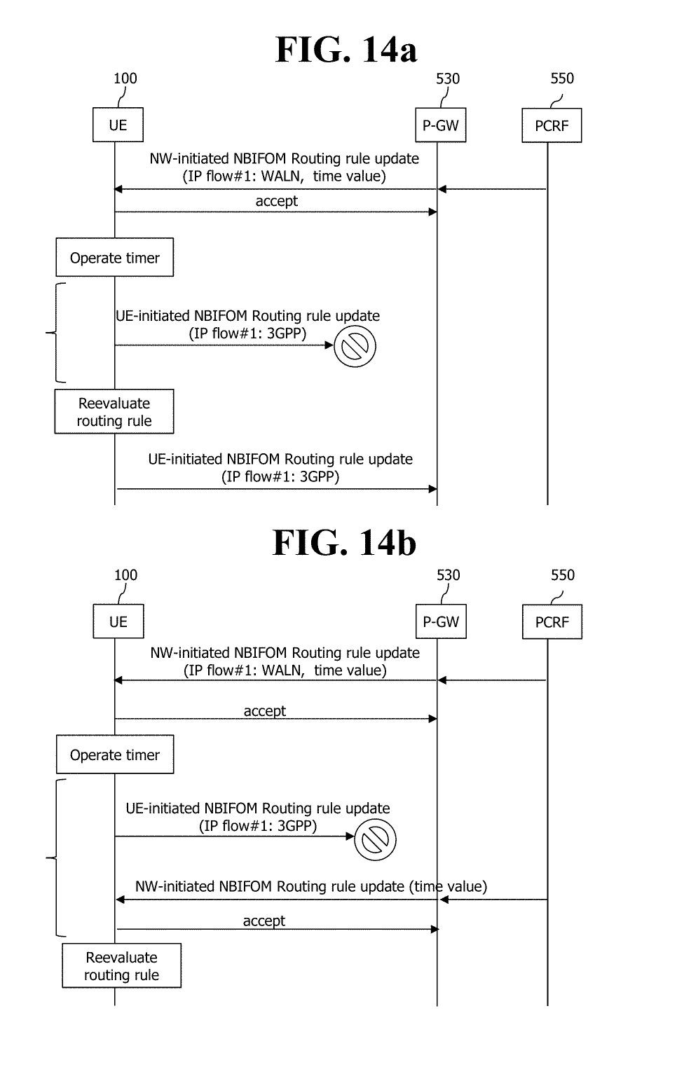

FIGS. 14a and 14b are flowcharts illustrating the operation according to the first suggestion of the first disclosure.

Referring to FIG. 14a, the network, for example, P-GW 530, transmits the routing rule update request message to the UE 100 in order to hand the IP flow #1 of the UE from 3GPP access to WLAN access. The routing rule update request message may include information on the WLAN access which is the target access for the IP flow #1, and the timer value. The timer value may be calculated in the P-GW 530 or PCRF 550. The calculation of the timer value will be described later.

The UE 100 determines whether to accept the request to update the routing rule. If accepted, the acceptance message is transmitted with respect to the routing rule update request message.

Further, the UE 100 operates the timer according to the timer value within the request message.

The UE cannot transmit the routing rule update request message in order to return the IP flow #1 from WLAN access to 3GPP access against the will of the network during the operation of the timer.

If the timer expires, the UE 100 may reevaluate the routing rule and transmit the routing rule update request message for returning the IP flow #1 from WLAN access to 3GPP access.

Meanwhile, as known with reference to FIG. 14b, the UE cannot transmit the routing rule update request message during the operation of the timer, but the network can transmit the routing rule update request message, through which the network may update to a new timer value.

I-2. Second Suggestion: When the Routing Rule Update Request of the UE is Rejected

According to the second suggestion of the present specification, when transmitting the rejection message to the routing rule update request message of the UE 100, the network may enable one of the following informations to be included in the rejection message and transmitted.

1) Reason of Rejection

2) Relative Intensity of Rejection:

Whether the UE should certainly consider the meaning of the rejection given in the network in the following operation or the selection may be optional to the UE may be implicitly included.

3) Implicit Information on the Network Situation:

Information on the network information which the UE cannot directly know but only can indirectly known in consideration of the characteristic of the service provider which does not want to directly inform the UE of the network situation

The UE may compare preset information or the setting information separately provided from the network with implicit information on the network situation included in the rejection message so as to be considered when transmitting the same routing rule update request message next time.

For example, when the network rejects the routing rule update request for the specific access of the UE, the value for implicitly recognizing the network situation may be transmitted.

4) Timer Value of Prohibiting IP Flow Movement Request to Specific Access:

When the update request of the routing rule of moving specific IP flow from 3GPP access to WLAN access is rejected by the network, timer value for blocking the same attempt of the UE

Specific access and timer value may have been explicitly mapped within the rejection message. Or the rejection message is a response to the routing rule update request message, and thus the information on the specific access may be omitted and only the timer value may be included. In this case, the UE may implicitly know that the timer value is about a specific access included in the routing rule update request message having been transmitted by the timer.

Basically the granularity of the timer of prohibiting the same request has been described in the IP flow unit of updating the routing rule, but the network situation may be directly or indirectly included, and thus it may be applied to several granularities or the combination thereof in an extended manner as follows. Further, they may be individually operated.

i. IP flow

ii. PDN connection

iii. UE

iv. Access network

v. Group, etc. operated for the purpose of management in network or subscriber information

The present invention has been described centering on the embodiment which may be considered when information is delivered from the network to the UE 100 and the UE 100 attempts the next request based on the information, but this may also be applied to the embodiment that in the reverse manner, the UE 100 delivers information to the network and the network decides the next operation based on the information in an extended manner.

It may be P-GW or PCRF mentioned in the present invention and includes all interactions between the network nodes.

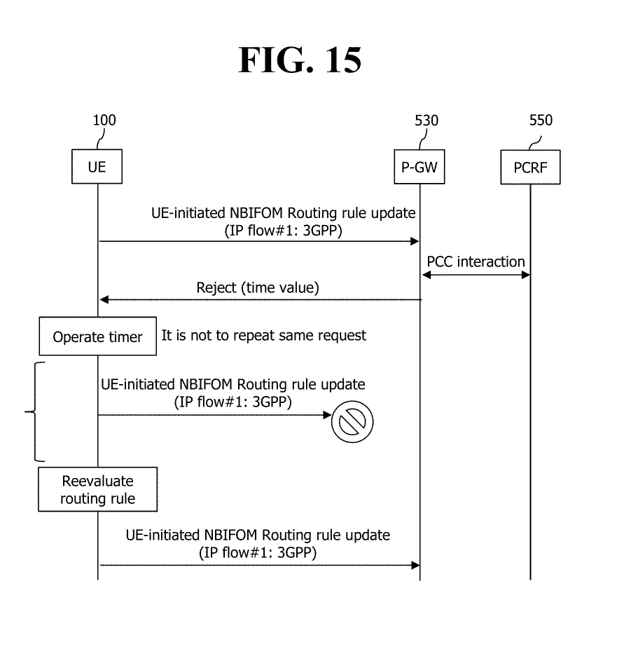

FIG. 15 is a flowchart illustrating the operation according to the second suggestion of the first disclosure.

Referring to FIG. 15, the UE 100 requests the routing rule update to the network, e.g., P-GW 530, in order to hand IP flow #1 over from the WLAN access to the 3GPP access.

Yet, the network transmits a rejection message for several reasons (e.g., issues such as the load situation of the access, policy, the access of the amount of use, etc.). At this time, the timer value may be include din the rejection message. The timer value may be calculated by P-GW 530 or PCRF 550. The calculation of the timer value may be described later.

The UE 100 operates the timer according to the timer value within the rejection message. At this time, the UE 100 may implicitly know that the timer value is about the WLAN access included in the routing rule update request message having been transmitted by the UE 100.

The UE 100 cannot transmit the routing rule update request message for moving the IP flow #1 from WLAN access to 3GPP access against the will of the network during the operation of the timer.

If the timer expires, the UE 100 may reevaluate the routing rule and transmit the routing rule update request message for moving the IP flow #1 from WLAN access to 3GPP access.

II. Second Disclosure of the Present Specification: Improvement for Resolving a Ping-Pong Problem

The second disclosure of the present specification suggests a solution for resolving the ping-pong problem which may be generated as the UE-initiated NBIFOM and the network-initiated NBIFOM are independently attempted.

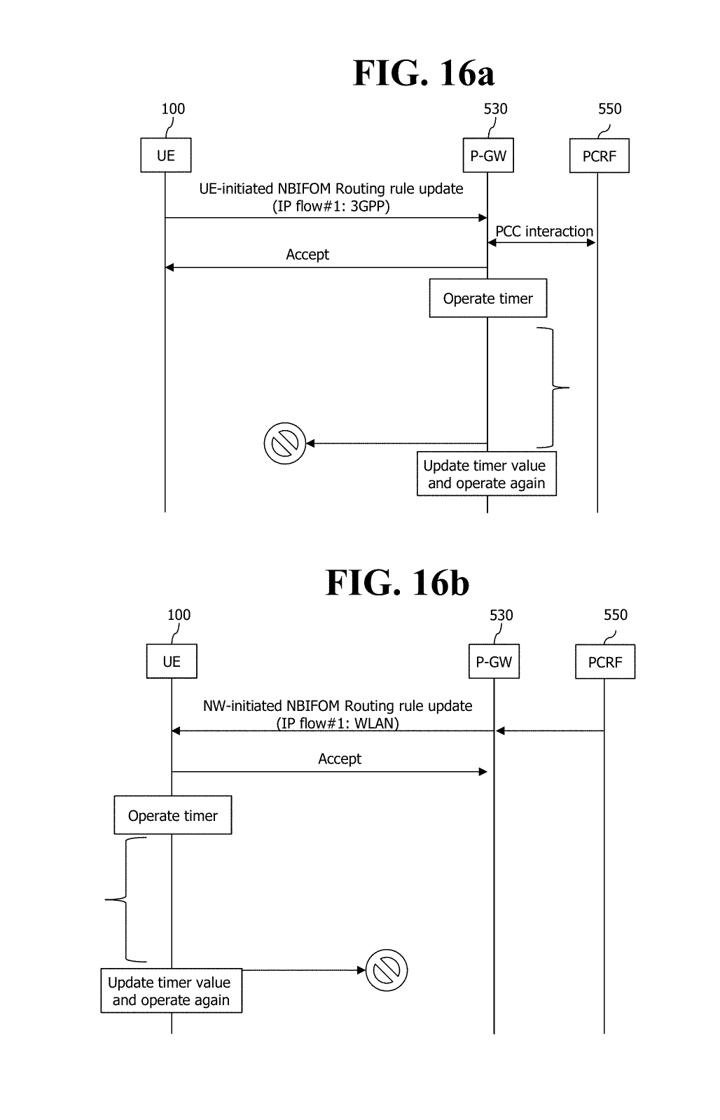

FIG. 16a is a flowchart illustrating the operation of the network according to the second disclosure of the present specification.

Referring to FIG. 16a, the UE 100 transmits routing rule update information to the network, i.e., P-GW 530 in order to move IP flow #1 to specific access (e.g., 3GPP access).

The network, i.e., P-GW 530, checks a currently usable access according to the request of the UE.

Thereafter, the network, i.e., P-GW 530, determines whether to accept the update request of the routing rule according to the request of the UE through the interaction with the PCRF 550. If accepted, the network, i.e., P-GW 530 transmits the acceptance message. As such, the IP flow #1 is moved to the specific access (e.g., 3GPP access).

Next, the network, i.e., P-GW 530, operates the internal timer. The timer is used to prevent the IP flow #1 from being moved again within a short period of time. The value of the timer may be a value having been set in advance in the network, i.e., P-GW 530, or a value calculated based on the information received from another network. Further, the value of the timer may be calculated based on the information received from the UE 100.

Basically, the granularity of the timer has been described in the IP flow unit of updating the routing rule, but it may be applied to several granularities and the combination thereof as follows in an extended manner. Further, they may be individually operated.

i. IP flow

ii. PDN connection

iii. UE: the update of the routing rule is not requested to the UE irrespective of the IP flow/access network.

iv. Access network: the update of the routing rule with the specific access as the target is not requested irrespective of the IP flow.

v. Group operated for the purpose of management in the network or subscriber information: The update of the routing rule is not requested for the group to which the corresponding UE belongs irrespective of the IP flow/access, etc.

Meanwhile, referring to FIG. 16a again, even if the situation that the routing rule should be updated has occurred, the network, i.e., P-GW 530, does not transmit the update request of the routing rule to the UE 100 before the timer expires.

If the timer expires, the network, i.e., P-GW 530, reevaluates the update request of the routing rule, and then the update request may be transmitted to the UE or the transmission may be abandoned depending on the evaluation result. Further, the network, i.e., P-GW 530, may update the timer value and may operate again.

FIG. 16b is a flowchart illustrating the operation of the network according to the second disclosure of the present specification.

Referring to FIG. 16b, the network, i.e., P-GW 530, transmits routing rule update information in order to move IP flow #1 of the UE to a specific access (e.g., WLAN access).

The UE 100 checks a currently usable access according to the request of the network.

The UE 100 determines whether to accept the update request of the routing rule according to the request of the network. If accepted, the UE 100 may transmit the acceptance message. As such, the IP flow #1 is moved to a specific access.

Next, the UE 100 operates the inner timer. The timer is to prevent the IP flow #1 from being moved again within a short period of time. The value of the timer may have been set within the UE 100 or calculated based on the information received from the network.

Basically, the granularity of the timer has been described in the IP flow unit of updating the routing rule, but it may be applied to several granularities and the combination thereof as follows in an extended manner. Further, they may be individually operated.

i. IP flow

ii. PDN connection

iii. Access network: The update of the routing rule with the specific access as target is not requested regardless of the IP flow.

Meanwhile, referring to FIG. 16b again, even if the situation that the routing rule should be updated has occurred, the UE 100 does not transmit the update request of the routing rule if the timer has not expired.

If the timer expires, the UE 100 may reevaluate the update request of the routing rule, then may transmit or abandon transmission depending on the result of evaluation. Further, the UE 100 may update the timer value and operate again.

III. Timer Value According to the Suggestions of the Present Specification

III-1. Reason why the Network Delivers the Timer Value to the UE 100

As illustrated in FIGS. 14a, 14b and FIG. 15, the network transmits the timer value to the UE 100 in order to prohibit the request to move the IP flow to the specific access based on the statistical information on the amount of use of the traffic which has passed subscriber information and specific access which may be most easily recognized by the network. Namely, such information is information which may be accurately obtained in the network rather than the UE 100.

For example, the network may recognize subscriber information as in the case that a specific subscriber has subscribed a fee system of using or prohibiting a specific access in a specific environment (day time or night time) or has subscribed a fee system having a limit in the amount of use. Further, the network may collect statistical information on the amount of use of data for the reasons such as the charge of fees.

In addition, the network may analyze the overall load of the network situation and recognize the traffic load or confusion situation which passes the specific access at a certain point of time/during certain time period. Such a network situation cannot be easily recognized by the UE 100 and is information which may be obtained by the information exchange between network nodes.

Hence, in the present invention, the network calculates the timer value based on information which may be recognized by the network. As the network provides such a timer value to the UE 100, the UE 100 may prevent the repetitive request of transmission to the network or a request having a high possibility of rejection from the network in advance, thereby preventing the waste of the signaling overhead and other network resources.

III-2. Scheme that the Network Calculates the Time Values Delivered to the UE 100

For example, the network may calculate the timer value according to the following equation. The timer value is shown as Tnu in the following equation.

Tnu=α*(Ts)⊙β*(To)⊙γ*(Tr)⊙ε*(Tx)⊙Φ*(1/Ty) . . .

Here, ⊙ means the operation which may be defined by the service provider according to the policy. The easiest example includes addition and multiplication.

Further, α, β, γ, ε, and Φ means the basic constant value. The constants may be calculated based on the random function within a preset specific range. The service provider may select some of the constants as 0. The constant value may be a fraction in order to give weight between the parameters.

The Ts is the difference between the time allowed by the subscriber information and the current time. For example, if the subscriber can use a specific access network from 2 o'clock and the current time is 1 o'clock, it may be that Ts=1 hour. Further, as another example, if the UE has exceeded the capacity for using a specific access per month, the remaining time until the beginning of the month when the statistics of the amount used are initialized on the basis of the current time may become Ts. Namely, as the value of Ts gets bigger, the timer value gets bigger. If the value of a is set to 1 and all other constants are set to 0, Tnu may be set with only the absolute time value. In this case, the UE may not repeatedly request for the absolute time for which the network would like accept the request.

The To may be a time value which is set according to the overload level of the network which may be recognized in the network. Namely, as the overload of the specific network gets serious, the value of To gets bigger and the value of the timer gets bigger. However, the value having been set in the network, not the statistical value, by the overload of the actual network may be used for the reason of the network operation such as the fault recovery of a certain region. When the timer value for the re-request within the time allowed by the subscriber information is given, evaluating the request after certain time is expected, and in this case, it may be effective to consider the dynamic timer value on the basis of the To value having reflected the network overload situation.

The Tr is the statistical amount of the actually used traffic via the specific access for a certain amount of time by the user. For example, if there is a limit in the specific access use per month, in the network, the actually used amount of traffic may be measured, and as the value increases, the timer value may increase. However, Tr value may be modified in various ways to be used. For example, if modified as the total use-allowed remaining amount, not the actually used amount, or modified as the ratio of the used amount to the entire allowed amount, it is not that as Tr value increases, Tnu value always increases. In this case, Tx and Ty values may be used as a general expression equation as follows.

The Tx expresses the time value having been set by the randomly-set criterion in the network. For example, the Tx may express the parameter value in the proportional relation.

The Ty may express the time value having been set by the randomly-set criterion in the network. For example, the Ty may express the parameter value in the inverse proportional relation.

III-3. Reason why the Network or UE 100 Internally Set the Timer Value

FIG. 16a shows that the network internally sets the timer value, and FIG. 16b shows that the UE 100 internally sets the timer value. The setting is performed in this way in order to prevent the waste of the signaling overhead and other network resources of the entire network by preventing in advance the repetition of the reverse request between the network and the UE 100.

III-4. Scheme that the Network or UE 100 Calculates the Internally-Set Timer Value

The network or the UE may calculate the internally-set timer value according to the equation as follows. In the equation below, the timer value is denoted as Tself.

Tself=α*(Tc)⊙β*(Tp)⊙ε*(Tx)⊙Φ*(1/Ty) . . .

Here, the ⊙ means the operation which may be defined by the service provider according to the policy. The easiest example includes addition and multiplication.

Further, α, β, γ, ε, and Φ means the basic constant value. The constants may be defined per service provider or calculated based on the random function within a preset specific range. The service provider may select some of the constants as 0. The constant value may be a fraction in order to give weight between the parameters.

The Tc means the accumulated number of times for changing the currently-set access network for a certain period of time. For example, the number of times of request for converting to the WLAN access by the UE when the network has set the setting that the network passes the 3GPP access. The setting of Tself may be determined when the Tc value gets greater than the threshold value determined by the service provider, and as the Tc value gets greater, the timer, i.e., the value of Tself, gets greater.

The Tp is determined by the setting request intensity to a specific access sent by the opponent. For example, when the UE has requested the setting to the 3GPP access due to the WLAN access loss, the intensity of the setting request is high, and in this case, the network should not request the setting to another access, i.e., the setting to WLAN access, for a certain period of time. Namely, as the request intensity of the opponent gets bigger, the Tself tinier value gets bigger. Yet, the intensity of the setting request of the opponent may be directly/indirectly recognized and may be modified into a processed form and used. In this case, it may be the parameter of the inverse proportional relation, not the proportional relation, and Tx, Ty value may be used as a general expression as follows.

Tx expresses the time value having been set by a criterion which is randomly set in the network.

Ty expresses the time value having been set by a criterion which is randomly set in the network. For example, the parameter value in the inverse proportional relation is expressed.

The points having been explained until now may be implemented as hardware, which will be described with reference to FIG. 15.

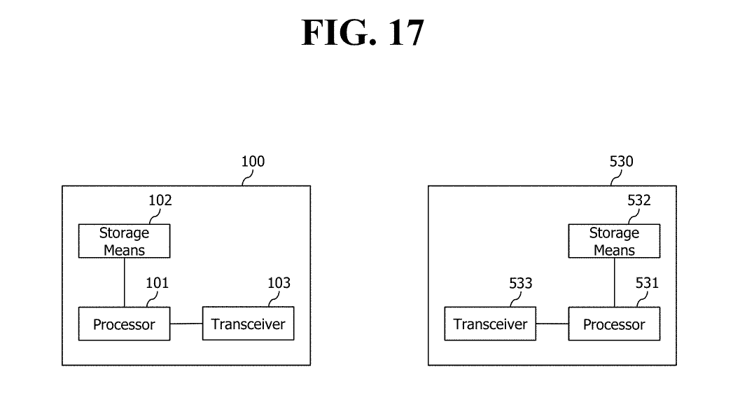

FIG. 17 is a block diagram of UE 100 and P-GW 530 according to an embodiment of the present invention.

As illustrated in FIG. 17, the UE includes a storage means 101, a controller 120, and a transmission/reception unit 103. The P-GW 530 includes a storage means 531, a controller 532, and a transmission/reception unit 533.

The storage means 101 and 531 store the above-described method.

The controllers 102 and 532 control the storage means 101 and 531 and the transmission/reception units 103 and 533. Specifically, The controllers 102 and 532 respectively the methods stored in the storage means 101 and 531. Further, The controllers 102 and 532 transmit the above-described signals through the transmission/reception units 103 and 533.

In the above, exemplary embodiments of the present invention have been explained, but the scope of the present invention is not limited to specific embodiments, and thus the present invention may be modified, changed, or improved in various forms within the scope of the concept of the present invention and the disclosure of the claims.

What is claimed is:

1. A method of updating a routing rule for moving a specific IP flow to a specific access, the method comprising:
receiving, by a user device, a update request message of a routing rule for NBIFOM (network-based IP flow mobility) initiated by a network,
wherein the update request message of the routing rule comprises a routing rule for moving the specific IP flow of the user device from a first access to a second access and a timer value calculated by the network, and
wherein the timer value is calculated by the network based on one or more of subscriber information, load information and statistical information;
transmitting, by the user device, an acceptance message for the update request of the routing rule to the network; and
operating a timer according to the timer value,
wherein before the timer expires, the user device is not able to transmit the update request message of the routing rule in order to return the specific IP flow from the second access to the first access.

2. The method of claim 1, wherein as the acceptance message is transmitted, the specific IP flow is moved from the first access to the second access.

3. The method of claim 1, wherein the update request message of the routing rule includes the timer value as an IP flow unit, a PDN connection unit, a user device unit or an access unit.

4. The method of claim 1, wherein the timer value is calculated by at least one of a difference between time allowable by subscriber information and current time, a time value set according to a network overload level recognizable in the network, and a statistical amount of an actually used traffic via a specific access.

5. The method of claim 1, if the timer expires, further comprising:
reevaluating the routing rule; and
transmitting the update request message for the routing rule according a result of the reevaluation.

6. A user device for updating a routing rule in order to move a specific IP flow to a specific access, the user device comprising:
a receiving unit for receiving a update request message of a routing rule for NBIFOM (network-based IP flow mobility) initiated by a network,
wherein the update request message of the routing rule comprises a routing rule for moving the specific IP flow of the user device from a first access to a second access and a timer value calculated by the network and
wherein the timer value is calculated by the network based on one or more of subscriber information, load information and statistical information;
a transmitting unit for transmitting an acceptance message to the network by the update request of the routing rule; and
a processor for operating a timer according to the timer value,
wherein before the timer expires, the user device is not able to transmit the update request message of the routing rule in order to return the specific IP flow from the second access to the first access.

7. The user device of claim 6, wherein as the acceptance message is transmitted, the specific IP flow is moved from the first access to the second access.

8. The user device of claim 6, wherein the update request message of the routing rule includes the timer value as an IP flow unit, a PDN connection unit, a user device unit or an access unit.

9. The user device of claim 6, wherein the timer value is calculated by at least one of a difference between time allowable by subscriber information and current time, a time value set according to a network overload level recognizable in the network, and a statistical amount of an actually used traffic via a specific access.

10. The user device of claim 6, wherein if the timer expires, the processor reevaluates the routing rule and transmits the update request message for the routing rule according a result of the reevaluation.
